(19) United States
(12) Patent Application Publication
(10) Pub. No.: US 2024/0025750 A1
(43) Pub. Date: Jan. 25, 2024

(54) A TWO-DIMENSIONAL ELECTROLYTE

(71) Applicant: National University of Singapore, Singapore (SG)

(72) Inventors: Mariana Caldeira Ferraz Da Costa, Singapore (SG); Antonio Helio De Castro Neto, Singapore (SG); Valeria Spolon Marangoni, Singapore (SG)

(73) Assignee: National University of Singapore, Singapore (SG)

(21) Appl. No.: 18/257,362

(22) PCT Filed: Dec. 6, 2021
(86) PCT No.: PCT/SG2021/050753

§ 371 Date: Jun. 14, 2023

(30) Foreign Application Priority Data
Dec. 14, 2020 (SG) 10202012491S

(51) Int. Cl. C01B 32/194; B82Y 40/00

(52) U.S. Cl. CPC C01B 32/194; B82Y 40/00; C01P 2004/136; C01P 2004/20

(57) ABSTRACT

Disclosed herein is a nanomaterial electrolyte formed from a modified two-dimensional nanomaterial having a surface, where the surface is modified by a plurality of functional groups selected from one or more of the group consisting of imine, sulfonic acid, sulfonamide, amine, hydroxyl, carboxylic acid, thiol, and amide on the surface of the modified two-dimensional nanomaterial, where the nanomaterial electrolyte is capable of reversibly adopting a flat two-dimensional conformation or a scrolled 1-dimensional conformation upon a change to its ambient environment. There is also disclosed a method of effecting a change in conformation from one form to the other (and back again).

### FIELD OF INVENTION

The current invention relates to two-dimensional electrolytes and their applications, as well as a method to change the conformation of the two-dimensional electrolytes by changes to the ambient environment.

### BACKGROUND

The listing or discussion of a prior-published document in this specification should not necessarily be taken as an acknowledgement that the document is part of the state of the art or is common general knowledge. One of the main characteristics of carbon is its numerous allotropes with different dimensionalities: fullerenes are molecules and, hence, zero dimensional (0D); carbon nanotubes are one-dimensional (1 D) structures; graphene is a two-dimensional (2D) structure; and graphite and diamond are three-dimensional (3D) structures. The distinct dimensionalities of carbon have led to different applications due to particular functionalities of carbon-based materials. Since the isolation of graphene in 2004, the field of 2D materials has grown dramatically due to their special properties and potential for applications in a large number of industrial areas. Unlike their standard 3D counterparts, 2D materials have special properties due to their low dimensionality, sharing characteristics of “soft” and “hard” materials. In 2D materials, electronic (hard) properties can be controlled by conformation (a soft property), leading to an intricate interplay between structure and functionality (V. M. Pereira & A. H. Castro Neto, Phys. Rev. Lett. 2009, 103, 046801). However, their assignment as intelligent materials that can undergo reversible dimensional transformation as a consequence of external stimuli responses is much less explored. The reversible morphology control of structures is an important mechanism to tune the properties of materials (Y. Xia et al., Adv. Mater. 2003, 15, 353-389 and Y. Zhang et al., Nat. Commun. 2015, 6, 6165). These systems are of great relevance for several applications, including drug-delivery, hydrogen storage, sensors, membranes for filtration, and structures for mimicking biological systems. In polyelectrolyte suspensions, for example, the electrostatic interactions are in the origin of their response to temperature and pH changes, and their fine balance is responsible for the reversible morphological transitions from molecular chains (1 D) to globular objects (0D) (M. Muthukumar, Macromolecules 2017, 50, 9528-9560; and T. Zhu et al., Nat. Commun. 2018, 9, 4329). Such dimensional reduction is a universal phenomenon since Coulomb and elastic forces tend to increase dimensionality, whereas van der Waals forces tend to reduce it (e.g. see FIG. 1). From the physical and chemical perspective, the electrical repulsion between the surface charge in a 2D material leads to a flat conformation. By changing the charge content of the dispersion, the surface charge density of a 2D material can be electrically screened and, due to its elasticity, a 2D material can undergo a conformational change by forming different morphologies, the most stable one being 1 D-like structures or scrolls. Amidst the large number of strategies to produce scrolls from 2D materials, shock cooling by liquid nitrogen followed by freeze-drying or lyophilisation is one of the most popular methods to prepare graphene oxide (GO) scrolls (T. Fan et al., Nanoscale Res. Lett. 2015, 10, 1-8; and L. Gao et al., RSC Adv. 2018, 8, 19164-19170). Other strategies to fabricate scrolls include high shear stress in a vortex fluidic under laser irradiation (T. M. D. Alharbi et al., Carbon N. Y. 2018, 137, 419-424), and the Langmuir-Blodgett (LB) technique (Y. Gao et al., Carbon N. Y. 2010, 48, 4475-4482). However, the reversible morphological transition of functionalized 2D materials as a function of changes in the external conditions has not been reported so far.

Therefore, there is a need to discover a new class of electrically charged-2D materials capable of undergoing reversible morphological transformations as a result of modifications to the environmental conditions.

### SUMMARY OF INVENTION

In a first aspect of the invention, there is provided a method of changing the conformation of a nanomaterial electrolyte, the method comprising:
(a) providing a nanomaterial electrolyte in an aqueous medium to provide a mixture having a first state; and
(b) subjecting the mixture to a change of one or more of the pH, ionic strength, temperature, pressure, sonication, and light to provide a mixture in a second state, wherein
   the first state of the mixture corresponds to the nanomaterial electrolyte predominantly being in a flat two-dimensional conformation or a scrolled 1-dimensional conformation; and
   the second state of the mixture corresponds to the nanomaterial electrolyte predominantly being in the opposite conformation to the first state, such that if the nanomaterial electrolyte is predominantly in a flat two-dimensional conformation in the first state, it is now predominantly in a scrolled 1-dimensional conformation in the second state, or vice versa, wherein
   the nanomaterial electrolyte comprises:
   a modified two-dimensional nanomaterial having a surface, where the surface is modified by a plurality of functional groups selected from one or more of the group consisting of imine, sulfonic acid, sulfonamide or, more particularly, amine, hydroxyl, carboxylic acid, thiol, and amide on the surface of the modified two-dimensional nanomaterial, wherein:
   the nanomaterial electrolyte is capable of reversibly adopting a flat two-dimensional conformation or a scrolled 1-dimensional conformation upon a change to its ambient environment, where the change in the ambient environment is due to a change of one or more of the pH, ionic strength, temperature, pressure, sonication, and light in the ambient environment; and
   the quantity of the plurality of functional groups is greater than that present in an unmodified form of the same two-dimensional nanomaterial.

In a second aspect of the invention, there is provided a nanomaterial electrolyte, the nanomaterial electrolyte comprising a modified two-dimensional nanomaterial having a surface, where the surface is modified by a plurality of functional groups selected from one or more of the group consisting of imine, sulfonic acid, sulfonamide or, more particularly, amine, hydroxyl, carboxylic acid, thiol, and amide on the surface of the modified two-dimensional nanomaterial, wherein: the nanomaterial electrolyte is capable of reversibly adopting a flat two-dimensional conformation or a scrolled 1-dimensional conformation upon a change to its ambient environment, where the change in the ambient environment is due to a change of one or more of the pH, ionic strength, temperature, pressure, sonication, and light in the ambient environment; and the quantity of the plurality of functional groups is greater than that present in an unmodified form of the same two-dimensional nanomaterial.

In a third aspect of the invention, there is provided a method of forming a nanomaterial electrolyte as described in the second aspect of the invention, the method comprising the steps of: (i) providing an unmodified two-dimensional nanomaterial; and (ii) reacting it with one or more functionalising reagents in the presence of a solvent to provide a nanomaterial electrolyte. In a fourth aspect of the invention, there is provided a drug delivery device comprising: a nanomaterial electrolyte as described in the second aspect of the invention; and a drug attached to a surface of the nanomaterial electrolyte, wherein the nanomaterial electrolyte is provided in a scrolled 1-dimensional conformation, such that the drug is encapsulated within an interior of the scrolled 1-dimensional confirmation and is released when the nanomaterial electrolyte adopts a flat two-dimensional conformation upon exposure to an acidic or a basic environment.

### DRAWINGS

FIG. 1 depicts the illustration of the morphological transitions of 2D-electrolytes and polyelectrolytes in dispersion: (a) a 2D-electrolyte changes from the flat 2D (top) to the scroll-like 1 D (bottom) configurations in dispersion under pH changes; and (b) the equivalent for a polyelectrolyte in solution, in which a 1 D molecular chain changes to a 0D globular structure.

FIG. 2 depicts the schematic representation of a typical 2D morphological transition process.

FIG. 3 depicts the characterisation of different 2D-electrolytes: (a-b) optical images of a dispersion containing reduced functionalized graphene oxide (rGO-SH-FITC) at pH 3.0, where flat 2D structures are observed; (c-d) the same material in a dispersion at pH 9.0, where scrolls are seen; HR-STEM images for (e) functionalised graphene (G-COOH) scroll; (f) with its interlayer distance; and AFM images and their respective height profiles of rGO-SH-FITC at (g, j) pH 3.0 (flat); and (h, i, k, l) pH 9.0 (scrolls).

FIG. 4 depicts the parameterization of a scroll using the geometry of an Archimedean spiral and optimized structures of (10,5)-scrolls: (a) dis the interlayer distance (measured from HR-STEM images), and the chosen parameterisation in terms of the initial, φ₀, and final, φ, angles implies the inner and outer radii rᵢₙ=r(φ=φ₀),rₒᵤₜ=r(φ) (also obtained from the microscopic images); (b) a perfect scroll; and (c) a scroll with oxygen in the inter-layer spacing.

FIG. 5 depicts the effect of sonication for the scrolling mechanism of a 2D-electrolyte at pH 4.5: (a) Scanning Electron Microscopy (SEM) images of graphene oxide (GO) with and without sonication; and (b) HR-STEM images of G-COOH with and without sonication (the light grey structure corresponds to the lacey carbon support film on the TEM grid).

FIG. 6 depicts the morphological configurations as a function of pH for different 2D-electrolytes. SEM images of: (a) GO; (b) rGO-SH; (c) rGO-SH-FITC; and (d) G-COOH. The pH for all samples were adjusted using HCl and KOH under sonication.

FIG. 7 depicts AFM images of the morphological transition of GO at different pH with their respective height profiles: (a, b) GO at pH 4.5 (original, 2D flat); (c-e) at pH 6.0 (1 D scroll); and (f, g) at pH 4.5, after readjustment from pH 3.0 (1 D scroll) to pH 4.5 (2D flat).

FIG. 8 depicts the characterisation of different 2D-electrolytes: (a) high resolution C1s X-ray photoelectron spectroscopy (XPS) spectra of GO, GO-SH, and rGO-SH; (b) high resolution S2p XPS spectrum of rGO-SH; (c) Zeta potential as a function of pH; (d) Raman spectra showing a slight increase of the relative intensity of the D band of GO after functionalisation (GO-SH) and hydrothermal reduction (rGO-SH); (e) Zeta potential as a function of pH for rGO-SH and rGO-SH-FITC; and (f) FTIR spectra for GO-SH, rGO-SH, FITC and rGO-SH-FITC. The dashed oval highlights the S═C═N bond for FITC spectrum.

FIG. 9 depicts the optical images for FITC control and rGO-SH-FITC (2D-electrolyte): (a) at pH 3.0, where 2D planar sheets are observed; and (b) at pH 9.0, where 1 D scroll structures are observed for the 2D-electrolyte.

FIG. 10 depicts the characterisation of graphene and G-COOH: (a) Raman spectra of graphene and G-COOH; (b) HR-STEM image of a 2D flat structure; high-resolution (c) C1s; and (d) N1s spectra of graphene and G-COOH.

FIG. 11 depicts the phase diagrams for 2D-electrolytes: (a) G-COOH; and (b) rGO-SH in an aqueous disperson. The experimental points for ζ potential vs. pH are shown by squares (2D flat) and circles (1 D scrolls) depending on the morphological state. The theoretical regions of instability are shown by the filling, for a given average flake size (0.48 μM and 2.33 μM for G-COOH and rGO-SH, respectively). The bending stiffness is 0.025 eV for soft GO-like materials (P. Poulin et al., Proc. Natl. Acad. Sci. U.S.A 2016, 113, 11088-11093). The Hamaker constant is 0.624 eV for graphene-like materials (R. R. Dagastine, D. C. Prieve & L. R. White, J. Colloid Interface Sci. 2002, 249, 78-83), but it is very large for r-GO-SH at pH>7 to simulate strong covalent S—S bonding formed in alkaline conditions.

FIG. 12 depicts the SEM images of different types of 2D-electrolyte morphologies identified in the dispersions at different pH and their approximated average aspect ratio (r): (a) 2D planar isolated sheets, with 1<r<3; (b) 2D planar agglomerated sheets, with 1<r<3; (c) 2D folded sheets (see arrows), with 3<r<5; (d) isolated 1 D scroll, formed by a single flake, with 5<r<15; and (e) twisted 1 D scroll, formed by many agglomerated flakes, with 6<r<20.

FIG. 13 depicts the statistical analysis for the 2D-electrolytes: (a) GO, (b) rGO-SH, and (c) G-COOH, at different pH with their respective distribution curves of the aspect ratio (r=length/width). The diagrams are fitted by the lognormal distributions given by F(r)=[C/σr(2π)^{1/2}]exp[−(ln r/r_{M})²/2σ²], where r is the aspect ratio with r_{M} is the median value, and C, σ are fitting parameters.

FIG. 14 depicts the statistical analysis at pH 4.5 and distribution of morphologies for GO at different pH: (a) size distribution curve of the aspect ratio of GO at pH 4.5, without sonication, in which planar sheets were predominantly observed; and (b) distribution of morphologies at different pH based on the statistical analysis.

FIG. 15 depicts the reversibility of the morphological transition. Representative SEM images of GO at pH 3.0 and after the pH readjustment to 4.5.

FIG. 16 depicts the statistical analysis of 2D-electrolytes (rGO-SH and G-COOH): (a) average aspect ratio as a function of pH for rGO-SH showing the tendency for scroll formation with increasing pH. The dot indicates the value achieved after pH readjustment, from pH 10.2 to 3.1; (b) statistical distribution of morphologies for rGO-SH (scrolled—including both twisted and isolated structures, folded and planar) identified in samples at different pH; (c) SEM images demonstrating the reversibility effect of rGO-SH from 1 D scroll structures at pH 10.2 to 2D flat sheets at pH 3.1, respectively; (d) average aspect ratio, showing the increase of 2D flat structures with increasing pH; (e) statistical distribution of structures for G-COOH; (f) HR-STEM images showing the reversibility process for G-COOH; and (g) zeta potential as a function of pH of functionalised graphene (G-COOH).

### DESCRIPTION

In a first aspect of the invention, there is provided a nanomaterial electrolyte, the nanomaterial electrolyte comprising:
a modified two-dimensional nanomaterial having a surface, where the surface is modified by a plurality of functional groups selected from one or more of the group consisting of imine, sulfonic acid, sulfonamide or, more particularly, amine, hydroxyl, carboxylic acid, thiol, and amide on the surface of the modified two-dimensional nanomaterial, wherein:
the nanomaterial electrolyte is capable of reversibly adopting a flat two-dimensional conformation or a scrolled 1-dimensional conformation upon a change to its ambient environment, where the change in the ambient environment is due to a change of one or more of the pH, ionic strength, temperature, pressure, sonication, and light in the ambient environment; and
the quantity of the plurality of functional groups is greater than that present in an unmodified form of the same two-dimensional nanomaterial.

In embodiments herein, the word “comprising” may be interpreted as requiring the features mentioned, but not limiting the presence of other features. Alternatively, the word “comprising” may also relate to the situation where only the components/features listed are intended to be present (e.g. the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa. The phrase, “consists essentially of” and its pseudonyms may be interpreted herein to refer to a material where minor impurities may be present. For example, the material may be greater than or equal to 90% pure, such as greater than 95% pure, such as greater than 97% pure, such as greater than 99% pure, such as greater than 99.9% pure, such as greater than 99.99% pure, such as greater than 99.999% pure, such as 100% pure. As used herein, the singular forms “a,” “an,” and “the” include plural referents unless the context clearly dictates otherwise. Thus, for example, reference to “a composition” includes mixtures of two or more such compositions, and the like.

When used herein, the term “two-dimensional nanomaterial” refers to a material having up to 10 layers of atomic thickness and other dimensions in nano- or micro-scale. When used herein the term “modified two-dimensional nanomaterial” refers to a two-dimensional nanomaterial that has been changed through the addition and/or replacement of functional groups. This may either be by the addition of functional groups to a material that was essentially devoid of functional groups (e.g. graphene) or the by the addition and/or change of functional groups that were present in the material. As an example of the latter class, unmodified graphene oxide may contain epoxides, alcohols and carboxylic acids. Through the chemistry disclosed herein, the epoxides may be ring-opened by the addition of further molecules, thereby increasing the amount of hydroxyl groups and also introducing a further functional group on the surface of the material (e.g. an amino group).

In certain embodiments, the number of functional groups present in a modified material that pre-existed with functional groups may be increased. This may be measured and quantified by any suitable method. For example, the functional groups may be verified and quantified by X-ray photoelectron spectroscopy (XPS) by calculating the atomic percentage of elements in order to identify the types of functional groups in each sample of a material (e.g. pre- and post-modification). By considering the relative peaks of every element, a quantification report including the atomic percentage of elements is provided. The degree of functionalization will depend on the type of functional groups and reaction that is undertaken. For graphene oxide functionalised with SH, for example, a high resolution C1 spectrum will show deconvoluted peaks that are attributed to C—Si and C—S and come from the molecule used for the functionalization (e.g. 3-mercaptopropyl trimethoxysilane). From this and the unfunctionalised graphene oxide spectrum before the functionalisation, it is possible to arrive at an estimate of the functionalization, which may show an overall increase in the number of functional groups present on the two-dimensional material. Other techniques, such as infrared and raman spectroscopy, can also be used qualitatively in this investigation.

As will be appreciated, while the nanomaterial electrolyte may be provided as the material per se, it may also be provided as an electrolyte formulation in a suitable medium, such as an aqueous environment. This aqueous environment may enable the nanomaterial electrolyte to undergo changes in its form due to changes in the ambient environment, such as by the change in pH or the like. As will be appreciated, while the plurality of functional groups may be selected one or more of the group consisting of imine, sulfonic acid, sulfonamide or, more particularly, amine, hydroxyl, carboxylic acid, thiol, and amide, these groups may be present in an ionic (e.g. ammonium, carboxylate) or free base/free acid form depending on the pH (or other environmental conditions) to which they are exposed. Thus, in embodiments of the invention that may be mentioned herein, the change in the ambient environment may be due to a change of one or more of the temperature, salt concentration, pH, ionic strength, and sonication in the ambient environment. In particular embodiments that may be mentioned herein, the change in the ambient environment may be due to a change of: one or more of pH, ionic strength, and sonication in the ambient environment; or one or both of pH and sonication in the ambient environment.

As shown in the examples below, a change in pH may change the electrical charge on the surface of the two-dimensional electrolytes disclosed herein, a change in one direction (higher or lower pH) may lead to the material adopting a substantially flat conformation, while a change in a second direction may result in it adopting a substantially scrolled conformation. When used herein, the term “substantially X conformation” may refer to a material where at least 55%, such as 65%, such as 70%, such as 75%, such as 80%, such as 85%, such as 90%, such as 95%, such as 99%, such as 99.99%, such as 100% of the material adopts the conformation X. In certain embodiments, where pH is used to control the conformation it may be necessary to supply additional energy to the system to enable the conformational change (e.g. the transition to scrolls may be energetically disfavoured due to the increase in elastic energy). This may be achieved by any suitable method, such as the use of a change in temperature, centrifugation, and light irradiation or, more particularly sonication. It will be appreciated that not all of the two-dimensional electrolyte adopts either the flat conformation or the scrolled conformation. A proportion of the two-dimensional electrolyte may adopt a folded conformation, which is part-flat and part-folded, as discussed in the examples section below.

The modified two-dimensional nanomaterial used in embodiments herein may be any suitable two-dimensional nanomaterial that has the ability to accept functionalisation of its surface. Examples of a suitable two-dimensional nanomaterial includes, but is not limited to, a graphene, a graphene oxide, a reduced graphene oxide, a hexagonal boron nitride, a transition metal dichalcogenide and combinations thereof. In particular embodiments that may be mentioned herein, the modified two-dimensional nanomaterial may be selected from: one or more of a graphene, a graphene oxide and a transition metal dichalcogenide (e.g. molybdenum disulphide); one or more of a graphene and a graphene oxide; a transition metal dichalcogenide (e.g. molybdenum disulphide). In embodiments of the invention that may be mentioned herein, the modified two-dimensional nanomaterial may be a monolayer or is formed from 2 to 5 layers.

The plurality of functional groups may be selected from any combination of such groups mentioned herein. Indeed, it is possible that two or more of the functional groups may be present in the same attached moiety (e.g. an amine functional group and a carboxylic acid may be present in an amino acid moiety, such as a graphene surface functionalised with cysteine, where the thiol group forms a covalent bond to the graphene surface). For example, the plurality of functional groups may be selected from one or more of the group consisting of: (a) amine, hydroxyl, carboxylic acid, thiol, and amide; or (b) amino, hydroxyl, carboxylic acid, and thiol; or (c) hydroxyl, carboxylic acid, and thiol; or (d) carboxylic acid and thiol; or (e) amine and imine; or (f) hydroxyl, carboxylic acid, and sulfonic acid; or (h) thiol and sulphonamide; or (h) amine and carboxylic acid. Without wishing to be bound by theory, it is believed that the plurality of functional groups introduced into the modified 2D-nanomaterials allows one to tune the behaviour of the nanomaterial's morphological behaviour to suit any particular use. For example, by tuning it to respond to a particular set of ambient environmental conditions, as discussed herein.

In certain embodiments, the electrolyte according may be coated with a further material to provide it with additional functionality. For example, the electrolyte may be coated with a material selected from one or more of the group consisting of a polymer, a protein, a carbohydrate, and nanoparticles, optionally wherein the nanomaterial electrolyte is coated with a material selected from one or more of the group consisting of a poly(ethylene glycol) (PEG), a poly(methyl methacrylate) (PMMA), a protein, a silica, dextran, gold nanoparticles, gold nanorods, silver nanoparticles, platinum nanoparticles, titanium dioxide and silica nanoparticles. This extra-coating can be physically or covalently associated with the 2D-Electrolyte structure. In some embodiments, these coatings can be useful to protect the 2D-Electrolyte structure during the fabrication of a device. Some of these coatings may also be interesting for biomedical applications, for instance PEG, proteins and silica, since they can exhibit reduced toxicity or extended circulating life. In some embodiments, these additional coatings can be useful for energy applications, such as, solar cells and electrochemistry. For example metallic nanoparticle coatings can absorb light and, due the localized surface plasmon resonance, cause a local heating effect, which can trigger the morphological transition of the 2D-Electrolyte. Additionally or alternatively, the nanomaterial electrolyte may incorporate a fluorescent group covalently bonded to the surface. The functionalizing agent can be a fluorescent molecule, in which the changes in the conditions may also lead to a change at the molecule emission. This can be particularly useful for detection and sensor applications.

The nanomaterial electrolyte disclosed herein is particularly useful due to its ability to change conformation when the ambient environmental environment changes. Thus, in a further aspect of the invention there is disclosed a method of changing the conformation of a nanomaterial electrolyte as described hereinbefore, the method comprising: (a) providing a nanomaterial electrolyte in an aqueous medium to provide a mixture having a first state; and (b) subjecting the mixture to a change of one or more of the pH, ionic strength, temperature, pressure, sonication, and light to provide a mixture in a second state, wherein the first state of the mixture corresponds to the nanomaterial electrolyte predominantly being in a flat two-dimensional conformation or a scrolled 1-dimensional conformation; and the second state of the mixture corresponds to the nanomaterial electrolyte predominantly being in the opposite conformation to the first state, such that if the nanomaterial electrolyte is predominantly in a flat two-dimensional conformation in the first state, it is now predominantly in a scrolled 1-dimensional conformation in the second state, or vice versa. This material may be reversibly interconverted from the flat to the scrolled conformations upon changing the environmental conditions. Therefore, the method may further comprise the step: (c) subjecting the mixture to a change of one or more of the pH, ionic strength, temperature, pressure, sonication, and light in the ambient environment to revert the mixture back to the first state, such that the nanomaterial electrolyte reverts to its form in the first state.

An advantage associated with the currently disclosed method is that it does not require large variations of temperature or the use of solvents to effect a reversible morphological transition. Additionally, the process for the conformation shift is environmentally-friendly as it can be conducted in an aqueous environment, which also increases the potential applications that the electrolytes can be used for. Further the method is simple, versatile, template and solvent-free and reversible, which opens up applications a numerous fields, such as smart responsive materials (e.g. drug-delivery systems), batteries and sensors. As will be appreciated any suitable change in the ambient environment may allow for the conformational change. For example, the change may be a change of one or more of the temperature, salt concentration, pH, ionic strength, and sonication in the ambient environment, optionally wherein the change is a change of one or both of the pH and sonication in the ambient environment. More particularly, the change in the ambient environment may be due to a change of: one or more of pH, ionic strength, and sonication in the ambient environment; or one or both of pH and sonication in the ambient environment.

As will be appreciated, the nanomaterial electrolyte used in the method is the same as discussed hereinbefore. Therefore, for the sake of brevity discussion of the possible variations in this material will not be repeated.

In a further aspect of the invention, there is disclosed a method of forming a nanomaterial electrolyte described hereinbefore, the method comprising the steps of: (i) providing an unmodified two-dimensional nanomaterial; and (ii) reacting it with one or more functionalising reagents in the presence of a solvent to provide a nanomaterial electrolyte.

The unmodified two-dimensional nanomaterial may be selected from any suitable material. Examples of a suitable unmodified two-dimensional nanomaterial includes, but is not limited to, a graphene, a graphene oxide, a reduced graphene oxide, a hexagonal boron nitride, and a transition metal dichalcogenide. In particular embodiments, the unmodified two-dimensional nanomaterial is selected from one or more of a graphene, a graphene oxide and a transition metal dichalcogenide (e.g. molybdenum disulphide). More particularly, the unmodified two-dimensional nanomaterial may be selected from one or more of a graphene and a graphene oxide. Alternatively, the unmodified two-dimensional nanomaterial may be a transition metal dichalcogenide (e.g. molybdenum disulphide). In embodiments of the invention that may be mentioned herein, the unmodified two-dimensional nanomaterial is a monolayer or is formed from 2 to 5 layers.

The functionalizing agent can be any bifunctional (or tri-, tetra- etc) molecule that can be attached to the surface of the 2D material by one of the functional groups and has at least one other functional group that is responsive to environmental changes (such as pH). For all types of 2D-electrolytes mentioned herein, the functionalising agent can be more than one type of molecule. Linkers may be selected to extend the types of molecules/groups and functional groups. For graphene oxide, for example, the functionalizing agent can be any bifunctional (or trifunctional etc.) molecule that can be attached to graphene oxide (GO) surface and has functional groups that can protonate or deprotonate under specific circumstances. The molecules can be attached through the epoxy or hydroxyl groups on the GO. Examples include, but are not limited to, aminosilanes, carboxylicsilanes, thiolsilanes, such as (3-Aminopropyl) triethoxysilane, (3-Aminopropyl) trimethoxysilane, (3-Mercaptopropyl) methyldimethoxysilane, among others. The functionalization with silane molecules is also called silanization. The GO functionalizing agent can also be a nucleophilic agent that binds to epoxy or carboxylic functional groups on the GO surface. Amination or esterification can be performed in this case. Examples include, but are not limit to, bi- or polyfunctional amines such as ethidenediamine (EA), 1, 6-hexanediamine (HA), Triethylenetetramine (TETA). In certain embodiments, some intermediate molecules can be used to activate the functional groups and improve the yield of the reactions. Examples include, but are not limit to, 1-Ethyl-3-(3-dimethylaminopropyl)carbodiimide (EDC), N-hydroxy succinimide (NHS) or thionyl chloride SOCl₂. The GO functionalization can be combined with reduction of the GO molecules, to minimize the interference of the remaining groups on the GO surface during the scrolling/unscrolling process. The reduction can be either performed thermally, by a controlled temperature treatment, or chemically, using reducing agents such as ascorbic acid, hydrazine or sodium borohydride.

A functionalization agent for pristine graphene can be a molecule that attacks the sp² carbon atoms of graphene. The reaction can be performed in organic solvents, such as DMF, DMSO, NMP, DMSO, with diazonium salts and azido molecules. Examples of molecules include, but are not limited to, any azidocompounds (e.g., azido-OH, azido-COOH, azido-NH₂, azido-polymer) such as 5-azidopentanoic acid, azido-dPEG-amine, azido-dPEG-acid, 3-azido-1-propanol, 3-azido-1-propanamine. The functionalization agent for pristine graphene can also be a dienophile. Examples include, but are not limited to, azomethine ylides, which react through a 1,3 dipolar cycloaddition in organic solvents such as DMF.

Other non-limiting examples of two-dimensional electrolytes include monolayer or few-layer transition-metal dichalcogenides. For example, MoS₂ can be functionalized with functional groups at the sulphur vacancies or taking advantage of their negative charge at 1T phase. In the first case, a bifunctional molecule containing thiol groups can be used. Examples include, but are not limit to, lipoic acid (LA) and derivatives, mercaptopropionic acid (MPA), thioglycerol (TG), cysteine. In the second case, electrophiles such as iodoacetamide can be used.

Thus, more generally, the one or more functionalising reagents may be selected from compounds that provide the nanomaterial electrolyte with one or more functional groups selected from the group consisting of imine, sulfonic acid, sulfonamide or, more particularly, amine, hydroxyl, carboxylic acid, thiol, and amide. Examples of these include the sets below, which sets may include sets of functional groups that may be introduced together. For example, the one or more functionalising reagents are selected from compounds that provide the nanomaterial electrolyte with one or more functional groups are selected from one or more of the group consisting of: (a) amine, hydroxyl, carboxylic acid, thiol, and amide; (b) amino, hydroxyl, carboxylic acid, and thiol; (c) hydroxyl, carboxylic acid, and thiol; (d) carboxylic acid and thiol; (e) amine and imine; (f) hydroxyl, carboxylic acid, and sulphonic acid; (g) thiol and sulphonamide; and (h) amine and carboxylic acid (e.g. an amino acid).

In particular embodiments, the one or more functionalising reagents may be selected from one or more of the group consisting of a thioamine, bifunctional sulphonic acid, an aminosilane, a carboxylicsilane, a thiolsilane, a bi-functional amine, a polyfunctional amine, an azido compound, a dienophile, a thioacid, and a haloacetamide. More particularly, the one or more functionalising reagents may be selected from one or more of the group consisting of sulfanilic acid, (3-aminopropyl) triethoxysilane, (3-aminopropyl) trimethoxysilane, (3-aercaptopropyl) methyldimethoxysilane, ethidenediamine (EA), 1,6-hexanediamine (HA), triethylenetetramine (TETA), an azido-OH, an azido-COOH, an azido-NH₂, an azido-polymer, lipoic acid (LA), lipoic acid derivatives, mercaptopropionic acid (MPA), thioglycerol (TG), cysteine, methyl iodide and iodoacetamide. Yet more particularly, the one or more functionalising reagents may be selected from one or more of the group consisting of (3-aminopropyl) triethoxysilane, (3-aminopropyl) trimethoxysilane, (3-aercaptopropyl) methyldimethoxysilane, ethidenediamine (EA), 1,6-hexanediamine (HA), triethylenetetramine (TETA), 5-azidopentanoic acid, azido-dPEG-amine, azido-dPEG-acid, 3-azido-1-propanol, 3-azido-1-propanamine, an azomethine ylide, lipoic acid (LA), lipoic acid derivatives, mercaptopropionic acid (MPA), thioglycerol (TG), cysteine, methyl iodide and iodoacetamide.

As noted above, step (ii) of the method may be conducted using an activating molecule (e.g. the activating molecule may be selected from the group consisting of 1-ethyl-3-(3-dimethylaminopropyl)carbodiimide (EDC), N-hydroxy succinimide (NHS), and thionyl chloride SOCl₂). In certain embodiments, the reaction product of step (ii) of the method may be subjected to reduction in a step (iii), which reduction step comprises reacting the reaction product of step (ii) with a reducing agent in the presence of a solvent (e.g. the reduction may be conducted using a reducing agent selected from one or more of the group consisting of ascorbic acid, hydrazine and sodium borohydride). In certain embodiments, the reaction product of step (ii) in the method may be subjected to reaction in a step (iv) with a fluorescent agent in the presence of a solvent (e.g. the fluorescent agent may be fluorescin isothiocyanate isomer I and the reaction product of step (ii) may comprise thiol functional groups).

In a further aspect of the invention, there is disclosed a drug delivery device comprising: a nanomaterial electrolyte as described hereinbefore; and a drug attached to a surface of the nanomaterial electrolyte, wherein the nanomaterial electrolyte is provided in a scrolled 1-dimensional conformation, such that the drug is encapsulated within an interior of the scrolled 1-dimensional confirmation and is released when the nanomaterial electrolyte adopts a flat two-dimensional conformation upon exposure to an acidic or a basic environment.

### EXAMPLES

### Materials

Graphene oxide (GO; 2 mg/mL in H₂O) was purchased from Sigma-Aldrich. Graphene flakes (XP grade powder) were purchased from 2D Materials Pte. Ltd.

### Analytical Techniques

The samples suspensions were drop casted on silicon (Si) substrates for XPS and SEM analyses, and on Si substrate with 300 nm silicon dioxide (Si/SiO₂) for Raman spectroscopy and atomic force microscopy (AFM).

### XPS

XPS measurements were carried out in a Kratos AXIS Ultra^{DLD} (Kratos Analytical Ltd) and the dispersions were drop casted on Si substrates. All spectra were calibrated using Si peak (99.4ev) from the substrate. Shirley-type background, peak fitting, and quantification were analysed by CasaXPS software (version 2.1.19), and the C1s spectrum was deconvoluted into an asymmetric graphite peak (˜284.5 eV) and the remaining peaks were fitted using Gaussian-Lorentzian GL (30) line shapes.

### AFM

AFM measurements were carried out in a Bruker Dimension Icon Microscope (Bruker Corporation, Billerica, MA, USA) operated in ScanAsyst tapping mode and scan lines of 512 under ambient conditions.

### Optical Microscopy

25 μL of thiolate GO (rGO-SH) (0.01 mg/mL) was deposited onto pre-cleaned glass slides. The dispersion was enclosed by a thin well of parafilm with an 8 mm×8 mm opening. Subsequently, a pre-cleaned coverslip was used to cover both the droplet and the parafilm. The coverslip prevents the formation of the meniscus and reduces the rate of evaporation of the solution. Finally, the edges were sealed with epoxy glue. Further characterization was carried out using an immersion 100× lens in an upright fluorescence microscope under bright field mode.

### Fourier Transform Infrared Spectroscopy (FTIR)

An ALPHA Platinum-ATR (Bruker Corporation, Billerica, MA, USA), instrument was used. For this, the aqueous suspensions of GO were freeze-dried, and prepared by the KBr disc method, and the spectra were obtained in an attenuated total reflection (ATR) mode.

### Raman Spectroscopy

Raman spectroscopy was performed in a WITec Alpha 300R (WITec Wissenschaftliche Instrumente und Technologie GmbH, Germany) with an excitation wavelength of 532 nm and a 100× objective lens.

### SEM

SEM was performed on Lacey carbon gold transmission electron microscopy (TEM) grids (TedPella) using FEI Verios 460 L FESEM (FEI Company, Hillsboro, OR, USA).

### High Resolution Scanning Transmission Electron Microscopy (HR-STEM)

HR-STEM analysis was performed on Lacey carbon gold transmission electron microscopy (TEM) grids (TedPella) using JEOL JEM-ARM200F (JEOL Ldt, Akishima, Japan) atomic resolution analytical microscope.

### Example 1. Synthesis of 2D-Electrolytes

2D-electrolytes were synthesised using organic molecules as reactive species to adduct different functionalities to GO and graphene by means of covalent modifications. The functionalization routes described below are only a few possible examples among many others.

GO-SH and rGO-SH

Initially, GO was dispersed in ethanol (1 mg/mL) by centrifugation. Next, 5 μL of (3-Mercaptopropyl) trimethoxysilane was added to 5 mL of the GO dispersion. The dispersion was kept under stirring for 24 h at room temperature, followed by two cycles of centrifugation in ethanol, and once in deionized water (DI water) to remove residues of silane molecules to give GO-SH. After functionalization (GO-SH), a mild hydrothermal reduction was performed to remove part of the COOH groups from the edges to obtain a much more controlled chemical surface to induce the scrolling mechanism. The reaction was conducted by adding ascorbic acid (7.5 mg) to the GO suspension (15 mL) under stirring and N₂ atmosphere. After 15 min, the temperature was increased to about 60° C. for 50 min. Finally, the system was washed with DI water to give rGO-SH.

rGO-SH-FITC

Fluorescein isothiocyanate isomer I (FITC) was used without further purification. For the functionalization, FITC was first dissolved in anhydrous DMSO at 1 mg/mL. Then, 1 mL of this FITC solution was added to 30 mL of rGO-SH (0.2 mg/mL, pH=6-7). The system was left under stirring for 6 h at room temperature and finally, dialysis was performed with ultrapure water to remove excess FITC. As a control, FITC solutions at pH 3.0 and 9.0 were drop casted on Si/SiO₂ (300 nm thickness) substrates, for which the absence of large structure was clear. The insertion of a fluorescent molecule on the graphene surface can expand its applications, e.g., in the biomedical field, demonstrating the multi-functional ability of these materials.

### G-COOH

Graphene was functionalized with 5-azidopentanoic acid via decomposition of the azide (N₃) group (FIG. 2). Upon thermal activation, the release of N₂ and addition of nitrene (R—N) onto graphene in DMSO led the molecules to be incorporated, resulting in graphene functionalized with carboxylic acids (—COOH) (J. Choi et al., J. Phys. Chem. C. 2009, 113, 9433-9435; L. H. Liu, M. M. Lerner & M. Yan, Nano Lett. 2010, 10, 3754-3756; and M. Zhao et al., Sci. Rep. 2016, 6, 37112). Typically, the conformation of functionalised graphene, GO sheets and other 2D materials is tuned by modifying the properties of the media (pH) and, consequently, the graphene's surface charge (FIG. 2). The reaction was performed as follows: 40 mL of 0.2 mg/mL of graphene in DMSO was prepared in a round-bottom flask under N₂ environment and sonicated for 15 min at 18° C. Then, the system was connected to a condenser and, under magnetic stirring, 5-azidopentanoic acid (250 mg) was added. The reaction was kept at 45° C. under N₂ atmosphere and stirring for 72 h. Since the initial bending of graphene sheets is unfavourable due to the increase of the elastic energy, this transition has to be assisted by sonication. Specifically, the reaction mixture was diluted in ultrapure water and sonicated for 10 min at 10° C. During sonication, an acid (H₂SO₄) or base (KOH) solution was added to the suspension to reach the desired pH, and the system was sonicated for additional 20 min at 10° C. The duration of sonication and temperature may vary depending on the 2D system. After that, the system was centrifuged and suspended in isopropanol. The process was repeated, followed by washing in water and sonication for 5 min at 10° C. to give G-COOH. The graphene displayed good stability in water after functionalization.

### Example 2. Characterization of GO, GO-SH, rGO-SH, rGO-SH-FITC and G-COOH

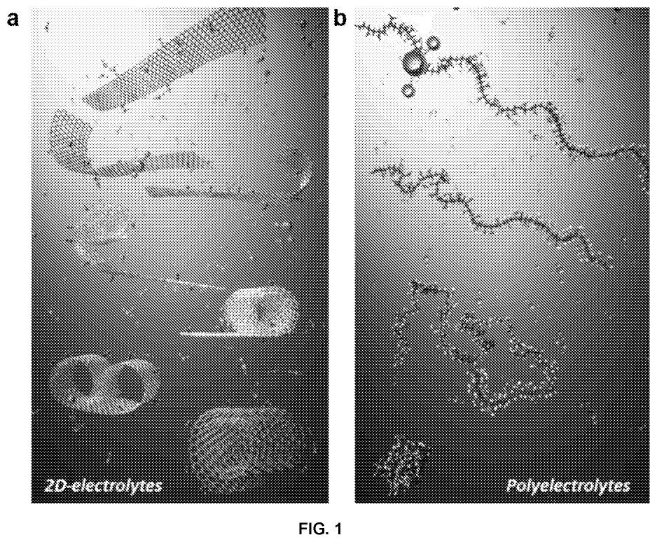

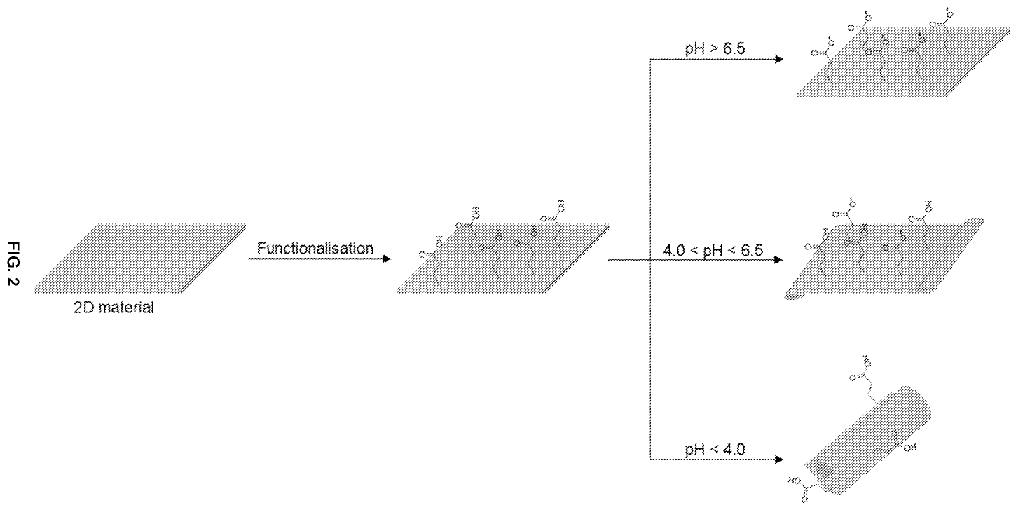

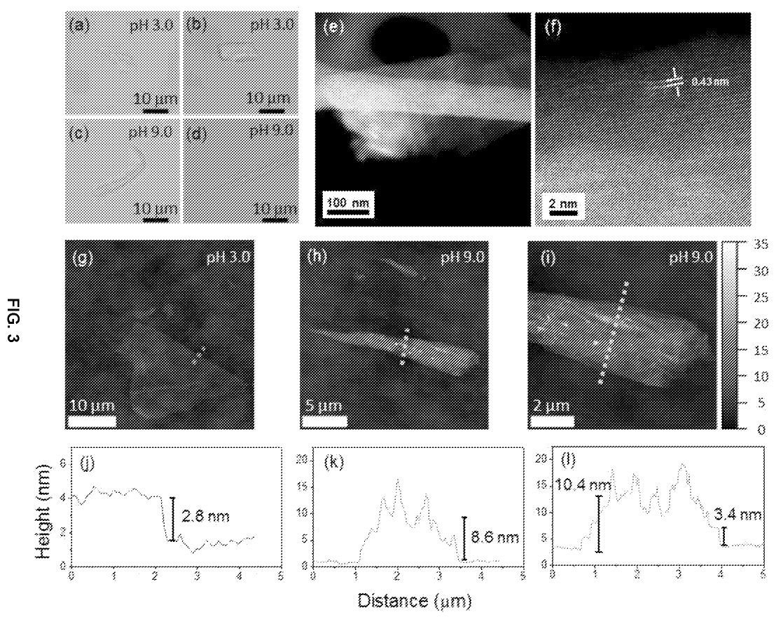

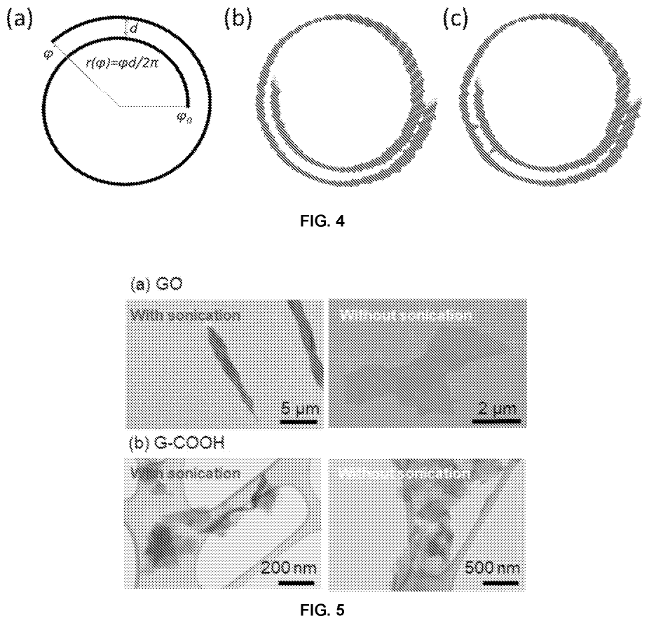

The 2D-electrolytes were characterized via optical microscopy to demonstrate the morphological transition in liquid dispersion as a function of pH. Reversible transitions from 2D to 1 D (from flat-like to scroll-like) structures in dispersions with different pH was observed (FIG. 3a-d). The scrolls were characterized microscopically using HR-STEM (FIG. 3e-f) and AFM under dry conditions (FIG. 3g-i), including their respective height profiles (FIG. 3j-1). The change in morphology was ubiquitous in all these characterization techniques. FIG. 3e-f shows a HR-STEM image of functionalized graphene, G-COOH, in which the scroll structure can be observed with its layers (FIG. 4a). One can see the layered structure of G-COOH, which is reminiscent of multiwall carbon nanotubes both in their pristine (J. H. Lehman et al., Carbon N. Y. 2011, 49, 2581-2602) and unzipped forms (J. Lim et al., Nat. Commun. 2016, 7, 10364; and L. Xue et al., Nat. Commun. 2018, 9, 3819). Hence, the scrolls have an Archimedean spiral structure with an interlayer distance of d˜0.43 nm, slightly larger than that of graphite (˜0.34 nm).

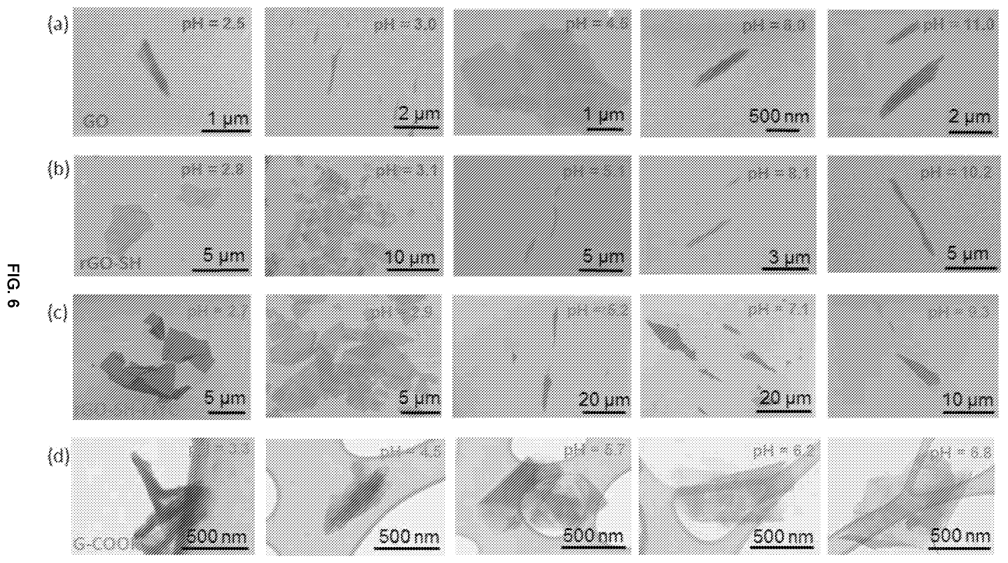

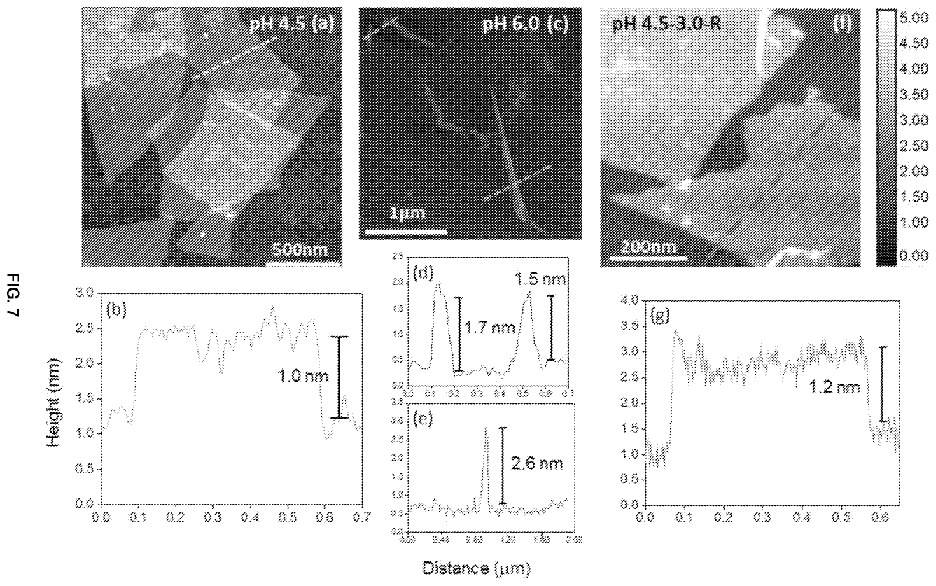

GO is an amorphous, non-stoichiometric material, which is hydrophilic and has properties of an acid when dispersed in water, with a 2D flat structure. However, after sonication, scroll formation was noted at this specific pH (FIG. 5). The morphological transition of GO under different pH can be observed by SEM (FIG. 6a) and AFM (FIG. 7). As GO has many oxygenated functional groups over a heterogeneous chemical surface, we observed 1 D scroll morphologies by SEM, after pH adjustments followed by sonication, in a wide range of pH values (FIG. 6a), even for extreme cases such as highly acidic (pH 2.5-3.0) or alkaline (pH 11) dispersions. For intermediate pH values (pH 6), several 1 D scroll structures were also observed. In FIG. 6b, we demonstrated that scroll-like structures were predominantly formed as pH increases. The thiol groups can deprotonate (SH→S⁻) at higher pH and, stimulated by sonication, bind internally forming disulphide bonds leading to the scroll-like morphology. In contrast, 2D flat structures were predominant at low pH. The reversible formation of disulphide bonds is a mechanism used by proteins, a 1 D-electrolyte, to maintain their tertiary structure (C. S. Sevier & C. A. Kaiser, Nat. Rev. Mol. Cell Biol. 2002, 3, 836-847).

GO samples were also characterized via AFM to image and assign the height profile of GO flat sheets at pH 4.5 (FIG. 7a-b), scrolled structures at pH 6.0 (FIG. 7c-e), GO flat sheets at pH 4.5 (FIG. 7f-g), and after pH readjustment (from pH 3.0 to pH 4.5) to demonstrate the reversibility of the scrolling mechanism. Unlike earlier reports of GO scrolling (Y. Gao et al., Carbon N. Y. 2010, 48, 4475-4482; Y. K. Kim & D. H. Min, Carbon N. Y. 2010, 48, 4283-4288; R. L. D. Whitby et al., ACS Nano. 2012, 6, 3967-3973; B. Tang et al., Chem. Mater. 2018, 30, 5951-5960; and T. M. D. Alharbi et al., Carbon N. Y. 2018, 137, 419-424), we have demonstrated the reversibility and generality of the morphological transition which is common to any 2D-electrolyte.

XPS characterizations of GO, GO-SH, and rGO-SH are presented in FIG. 8 and Table 1. The chemical states of elements and the presence of functional groups of GO were investigated by XPS (FIG. 8a). After deconvolution of the high-resolution C1s region, five different chemical states can be identified: 284.34 eV (C═C), 285.03 eV (C—C), 286.96 eV (C—O), 287.41 eV (C═O), and 288.38 eV (O—C═O). The high resolution C1s XPS spectra in FIG. 8a show that, after functionalization, the relative intensities increased in the regions related to C—Si and C—S binding energies, indicating that the silane and thiol groups were successfully introduced onto the GO surface (P. C. Ma, J. K. Kim & B. Z. Tang, Carbon N. Y. 2006, 44, 3232-3238). Also, the high-resolution S2p spectrum of rGO-SH shows the formation of C—S bonds (FIG. 8b). In addition, after reduction, the percentage of oxygenated groups, such as C═O (dark green colour) and O—C═O (violet colour), decreased by approximately 50%, when compared to GO-SH, as COOH groups were eliminated (Table 1). The colour of the resulting rGO-SH was slightly darker than GO-SH, thus agreeing with the reduction.

TABLE 1
Binding energy of the deconvoluted C1s XPS peaks and their relative
percentage area (in parentheses) of GO, GO-SH, and rGO-SH.

| | C═C | C—C | | | | | |
|---|---|---|---|---|---|---|---|
| | (sp²) | (sp³) | C—O | C═O | O—C═O | C—Si | C—S |
| GO | 284.52 | 285.06 | 287.01 | 287.50 | 288.77 | N.A. | N.A. |
| | (13.9%) | (42.4%) | (29.4%) | (9.9%) | (4.4%) | | |
| GO- | 284.50 | 285.12 | 287.11 | 287.81 | 288.95 | 283.67 | 286.01 |
| SH | (12.4%) | (34.5%) | (27.9%) | (11.4%) | (3.8%) | (2.2%) | (7.8%) |
| rGO- | 284.58 | 285.14 | 287.2 | 288.2 | 289.36 | 283.90 | 285.98 |
| SH | (16.5%) | (35.4%) | (29.6%) | (6.5%) | (1.8%) | (2.2%) | (8.0%) |

The zeta potential of GO-SH and rGO-SH was measured at different pH (from 2 to 12) to verify the stability of the dispersions and their surface charge densities (FIG. 8c). As expected, the zeta potential values were slightly less negative for pH higher than the pKₐ of the carboxylic groups (pH 4-5) after reduction. However, the zeta potential values are still highly negative, which makes it difficult to separate the S—H groups contribution. Overall, the pKₐ for SH groups was around pH 8-9. The pKₐ for SH groups is at basic pH, therefore, as the pH increases, the thiol groups can deprotonate (SH→S⁻) and, simulated by sonication, bind internally to form reversible disulfide bonds (C. S. Sevier & C. A. Kaiser, Nat. Rev. Mol. Cell Biol. 2002, 3, 836-847) to keep the scroll morphology. As such, no significant changes were observed between GO-SH and rGO-SH. Raman spectra (FIG. 8d) reveal that, after functionalization and reduction, the relative intensity of the D band was slightly increased. This is expected since the number of chemical groups and defects is increased, and phonon vibrations change after the reactions.

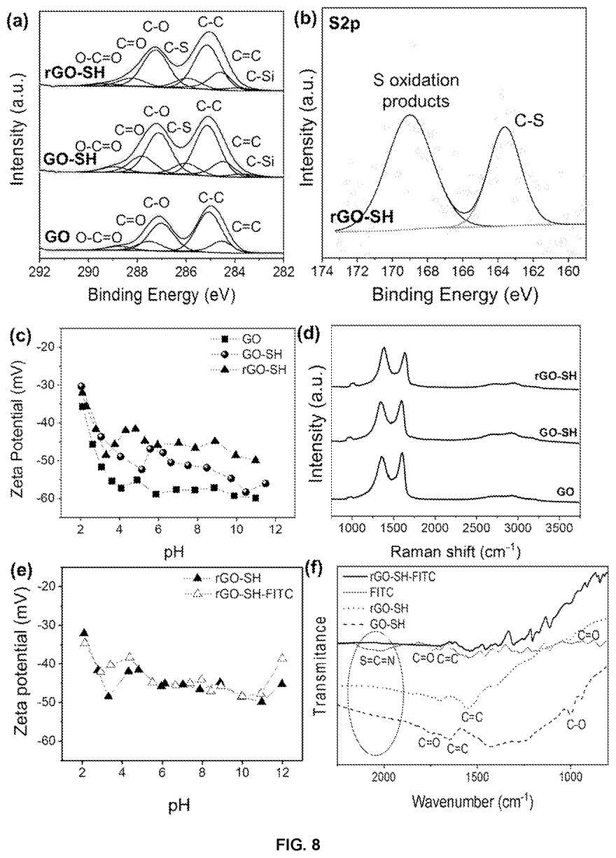

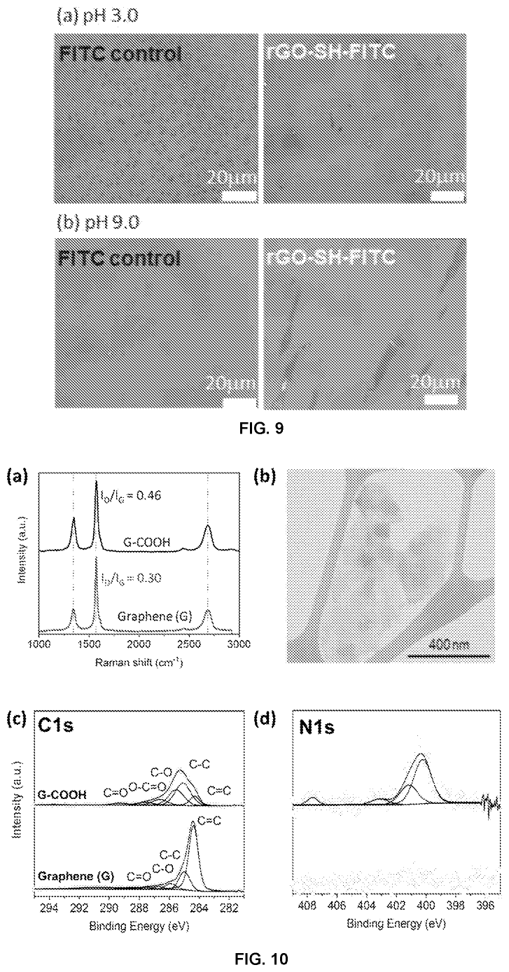

FTIR was acquired on all the Si substrates. FIG. 8f compares the spectra of FITC, GO-SH, rGO-SH and rGO-SH-FITC. It is expected that the isothiocyanate groups (S═C═N) bind to the thiol (S—H) groups of rGO-SH. After bond formation, the peak attributed to isothiocyanate group S═C═N in FITC molecules at 2051 cm⁻¹ disappeared from the FTIR spectrum, indicating that the covalent coupling of the FITC molecules with rGO-SH led to the formation of another 2D-electrolyte, rGO-SH-FITC. The mild reduction of GO-SH generated a decrease in the intensity of peaks attributed to the oxygenated groups of rGO-SH. Zeta potential as a function of pH revealed no significant changes due to the coupling of the FITC, indicating that free thiol groups were still attached to GO surface and survived to the morphological transition (FIG. 8e). Further, in analogy to the case of rGO-SH, 2D flat structures of rGO-SH-FITC were observed at low pH, and 1 D scrolls were observed at higher pH values (FIG. 6c), showing that the addition of the fluorescein molecule did not compromise the 2D electrolyte's pH responsive ability to change its morphology. Specifically, 2D planar sheets can be seen at pH 3.0, whereas 1 D scroll structures can be seen at pH 9.0 (FIG. 9).

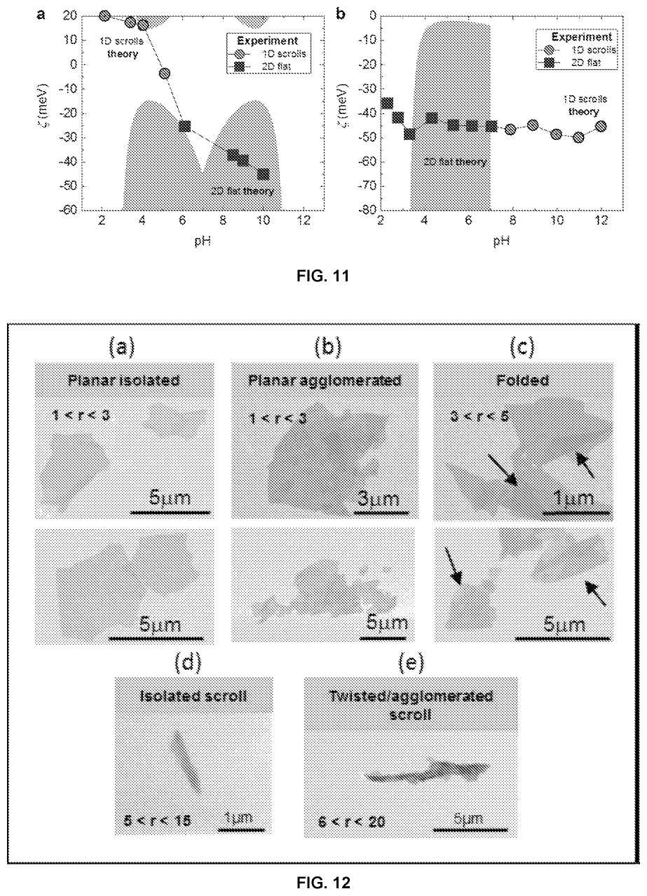

G-COOH was characterized by Raman, HR-STEM and XPS (FIG. 10). The increase of the ID/IG ratio in the Raman spectra (FIG. 10a) shows evidence of the covalent functionalization. The typical lateral size of the G-COOH sheets is in the range from 0.5 to 2 um (FIG. 10b). The morphology of G-COOH under different pH was investigated by STEM (FIG. 6d). From the original pH (around 6), acid or base was added with the intention to modify the graphene surface charge. 1 D scrolls were observed as the pH decreased. 2D flat structures were mainly observed at pH 7, whereas folded or partially scrolled structures were predominant at lower pH<5. The darker contrast and reduced lateral size at acidic pH indicate the formation of 1 D scroll structures. These results corroborate the phase diagram (FIG. 11a). We observed that two main factors are important in the scrolling formation: (i) the dispersion concentration, where at lower concentrations (0.04 mg/mL), the 1 D scroll structures are favored against the stacking and aggregation (B. Tang et al., Chem. Mater. 2018, 30, 5951-5960); and (ii) the effect of sonication, for which the 1 D scroll yield is considerably improved (FIG. 5). The deconvolution of the high resolution C1s XPS spectra for G-COOH shows, beyond the asymmetric C═C peak at 284.4 eV, other small peaks attributed to the presence of minority oxygen containing functional groups (FIG. 10c). They are ascribed as: hydroxyl (C—O) at 285.9 eV, epoxy/ether (C—O—C) at 286.7 eV, carbonyl (C═O) at 287.5 eV, and carboxylate (O—C═O) at 288.4 eV. Peaks from 291 to 294 eV are attributed to π-π* transitions (V. Datsyuk et al., Carbon N. Y. 2008, 46, 833-840; and H. Estrade-Szwarckopf, Carbon N. Y. 2004, 42, 1713-1721). By comparing both C1s spectra, one can observe a relative increase of the sp³ bonds and oxygen/nitrogen groups, after the functionalization with 5-azidopentanoic, corroborating the evidence for surface modification. The high resolution N1s spectra (FIG. 10d), after the first step of functionalization, can be resolved into two peaks at 400.3 and 401.3 eV. These energies differ from that expected for azido groups (N⁻=N⁺=N⁻) (G. Zorn et al., J. Phys. Chem. C. 2014, 118, 376-383), and are characteristic of tertiary amine and amide, agreeing with their attachment onto the graphene surface by elimination of N₂ (P. C. Ma et al., Carbon N. Y. 2010, 48, 1824-1834).

### Example 3. Statistical Analysis

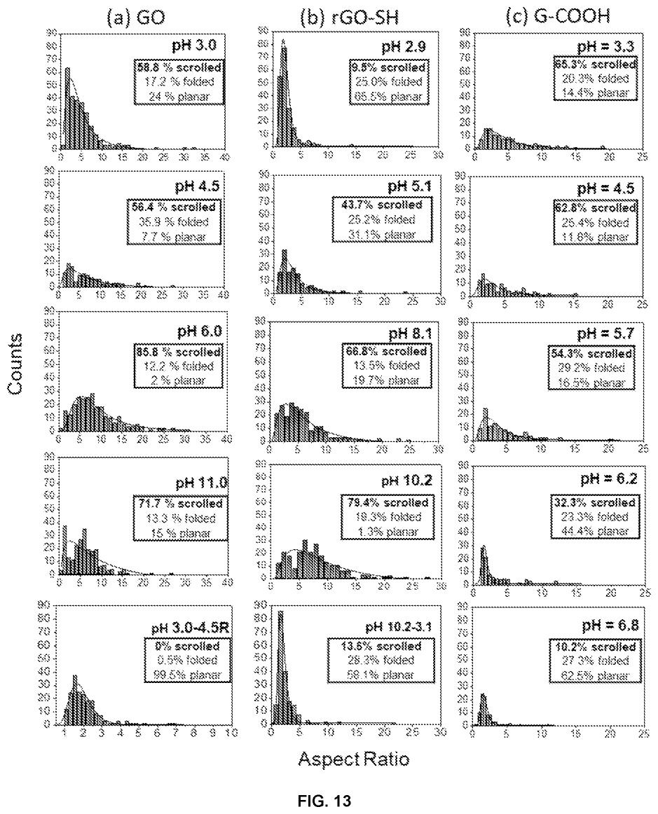

Since the morphological transitions are of statistical nature due to the distribution of sizes and thicknesses of the 2D material flakes used in our studies, the information collected by SEM and STEM was also used to interpret the results by statistical means. A statistical analysis was used to estimate the percentage of 1 D scrolls formed in the suspension as a function of pH. Dispersions with different pH were drop casted on appropriate substrates (silicon for GO and its functionalized forms, and TEM grids for G-COOH), and at least 100 structures were imaged to obtain their lateral dimensions (length, L—defined as the largest dimension—and width, W). Beyond the percentage of 1 D scrolls, we also identified other morphological configurations. The structures observed were further classified into planar, folded, scrolled and isolated, or scrolled and twisted, depending on their morphology (FIG. 12). As such, the number of counts based on multiple structures as a function of the aspect ratio (r=L/W≥l) was provided in a size distribution chart in FIG. 13.

### Results and Discussion

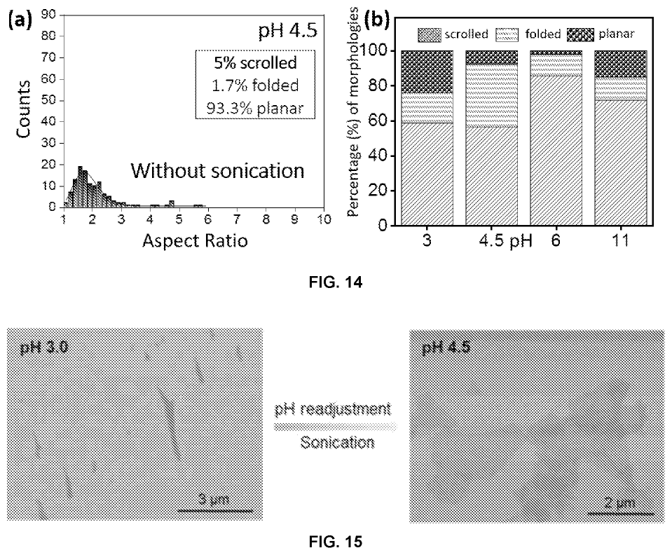

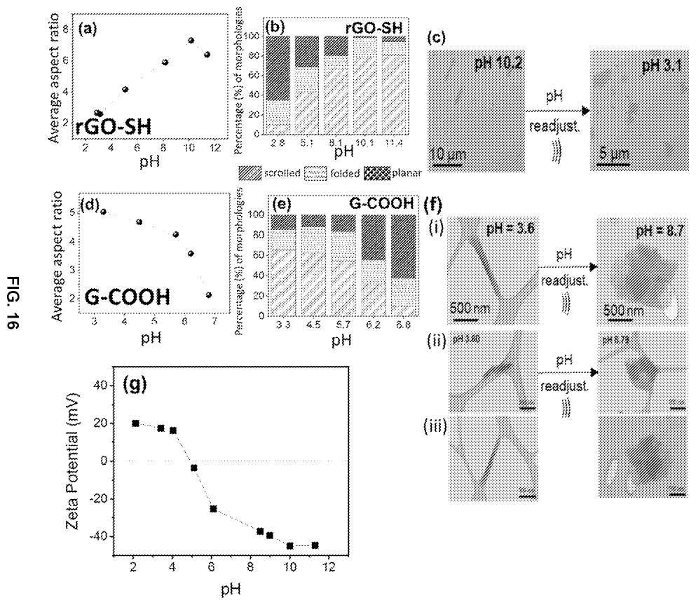

From the statistical analysis, we showed that GO formed scrolls in a broad pH range (from the lowest to the highest pH observed), which is mostly attributed to the chemical surface heterogeneity of this material (FIG. 13). In GO (FIG. 13a) and rGO-SH (FIG. 13b) dispersions, the average aspect ratio was changed with pH because both the length and width of scrolls depend on pH. The changing length indicates that the sample size also differs in each dispersion prepared at different pH. In G-COOH dispersion (FIG. 13c), the aspect ratio was changed mostly due to width, whose median value rapidly decreased with pH and saturated in acidic solutions at about 120 nm. The length remained nearly the same in all dispersions considered (the length median value was about 440 nm). This suggests that the flake size is the same at each pH considered, hence, the median width could be seen as the median value of the outer scroll diameter. Having in mind the interlayer distance (d=0.43 nm), the inventors estimated the maximum number of turns in their scrolls as Nₘₐₓ=D/(2d) that resulted in about 140 turns maximum (FIG. 3f). The actual number of turns was definitely less, as the inner turns should start at φ₀>>2π (FIG. 4a). Interestingly, GO presented a significant amount of scrolled species through all the pH range (FIG. 13a), but the amount of scrolls detected decreased dramatically under two circumstances for GO with original pH 4.5: (i) without sonication (FIG. 14a), and (ii) after pH readjustment from pH 3.0 to 4.5 (pH 3.0-4.5R) (FIG. 13a). These results indicate the reversible morphologic transition ability of this material (FIG. 15).

Alternatively, for the anionic 2D electrolyte rGO-SH, which has a much more controlled chemical surface, 2D flat sheets were mostly formed at pH 2.9, whereas 1 D scrolls were predominantly found at higher pH. The reversibility of this process, presenting a size distribution analysis within a pH sweep from 3 to 10 and back, can be seen in FIG. 13a. The average aspect ratio of 2D flat sheets was about 2.5, as can be seen in FIG. 16a. However, as the pH was raised towards the alkaline range, one can see a significant increase in the average aspect ratio up to about 7.0, owing to the increased presence of 1 D scroll structures. For rGO-SH (FIG. 16b) a clear trend emerged, demonstrating an increase in scroll content with increasing pH (from 9.5% at pH 2.9 to 79.4% at pH 10.2 of 1D scroll structures), while reducing the amount of 2D flat structures (from 65% at pH 2.9 to 1.3% for pH 10.2 of 2D flat structures) with similar reduction for folded structures. In FIG. 16c, we showed that the majority of the 1D scroll structures at pH 10.2 were unrolled at pH 3.1, in response to the external conditions. After pH readjustment, the average aspect ratio was reduced back to about 2.9 (FIG. 16a), nearly the same as observed for the planar sheets at lower pH values (FIG. 13b). Thus, FIGS. 16a and c demonstrate the reversibility of the process. The reversible formation of disulphide bonds is an important mechanism used by proteins, one type of polyelectrolytes, to maintain their tertiary structure.

For G-COOH, we observed the opposite behavior seen for rGO-SH, namely, a reduced percentage of scrolls in response to the increase of pH (FIG. 16d-e). As mentioned previously, these morphological changes can be explained by modifications of the G-COOH surface charge density. As the pH approaches the isoelectric point (around 4.9) and below, the carboxylic groups are fully protonated and, consequently, the hydrophobicity increases, resulting in folding, stacking and precipitation (R. L. D. Whitby et al., ACS Nano. 2012, 6, 3967-3973). At higher pH, the dissociation of carboxylic acid (COOH) to carboxylate (COO⁻) groups increases the negative surface energy (ζ-potential≥−30 mV, FIG. 16g), favoring 2D flat morphologies. Hence, the reversibility of the scrolling mechanism after pH readjustment from lower to higher pHs, in which planar structures were noted, was demonstrated (FIG. 16f). The interplay between extreme pH values demonstrates the ability of the 2D-electrolytes to undergo reversible morphological transitions.

The opposite response of two examples of 2D-electrolytes (rGO-SH and G-COOH) highlights the possibility of modulating the stimuli responsive behaviour based on the functional groups attached to the 2D material surface. Furthermore, the method is reversible, environment-friendly, and template- and solvent-free, allowing the 2D-electrolytes to expand their use in a wide range of applications, from batteries and sensors to drug delivery systems.

1. A method of changing the conformation of a nanomaterial electrolyte, the method comprising:
(a) providing a nanomaterial electrolyte in an aqueous medium to provide a mixture having a first state; and
(b) subjecting the mixture to a change of one or more of the pH, ionic strength, temperature, pressure, sonication, and light to provide a mixture in a second state, wherein
the first state of the mixture corresponds to the nanomaterial electrolyte predominantly being in a flat two-dimensional conformation or a scrolled 1-dimensional conformation; and
the second state of the mixture corresponds to the nanomaterial electrolyte predominantly being in the opposite conformation to the first state, such that if the nanomaterial electrolyte is predominantly in a flat two-dimensional conformation in the first state, it is now predominantly in a scrolled 1-dimensional conformation in the second state, or vice versa, wherein
the nanomaterial electrolyte comprises:
a modified two-dimensional nanomaterial having a surface, where the surface is modified by a plurality of functional groups selected from one or more of the group consisting of imine, sulfonic acid, sulfonamide, amine, hydroxyl, carboxylic acid, thiol, and amide on the surface of the modified two-dimensional nanomaterial, wherein:
the nanomaterial electrolyte is capable of reversibly adopting a flat two-dimensional conformation or a scrolled 1-dimensional conformation upon a change to its ambient environment, where the change in the ambient environment is due to a change of one or more of the pH, ionic strength, temperature, pressure, sonication, and light in the ambient environment; and
the quantity of the plurality of functional groups is greater than that present in an unmodified form of the same two-dimensional nanomaterial.

2. The method according to claim 1, wherein the method further comprises:
(c) subjecting the mixture to a change of one or more of the pH, ionic strength, temperature, pressure, sonication, and light in the ambient environment to revert the mixture back to the first state, such that the nanomaterial electrolyte reverts to its form in the first state.

3. The method according to claim 1, wherein the change in the ambient environment is a change of:
(a) one or more of the temperature, salt concentration, pH, ionic strength, and sonication in the ambient environment;
(b) one or more of pH, ionic strength, and sonication in the ambient environment; or
(c) one or both of pH and sonication in the ambient environment.

4. The method according to claim 1, wherein the modified two-dimensional nanomaterial is selected from one or more of a graphene, a graphene oxide, a reduced graphene oxide, a hexagonal boron nitride, and a transition metal dichalcogenide.

5. The method according to claim 1, wherein the plurality of functional groups are selected from one or more of the group consisting of:
(a) amine, hydroxyl, carboxylic acid, thiol, and amide; or
(b) amino, hydroxyl, carboxylic acid, and thiol; or
(c) hydroxyl, carboxylic acid, and thiol; or
(d) carboxylic acid and thiol; or
(e) amine and imine; or
(f) hydroxyl, carboxylic acid, and sulphonic acid; or
(g) thiol and sulphonamide; or
(h) amine and carboxylic acid.

6. The method according to claim 1, wherein one or both of the following apply:
(a) the nanomaterial electrolyte is further coated with a material selected from one or more of the group consisting of a polymer, a protein, a carbohydrate, and nanoparticles; and
(b) the nanomaterial electrolyte further comprises a fluorescent group covalently bonded to the surface.

7. A nanomaterial electrolyte comprising:
a modified two-dimensional nanomaterial having a surface, where the surface is modified by a plurality of functional groups selected from one or more of the group consisting of imine, sulfonic acid, sulfonamide, amine, hydroxyl, carboxylic acid, thiol, and amide on the surface of the modified two-dimensional nanomaterial, wherein:
the nanomaterial electrolyte is capable of reversibly adopting a flat two-dimensional conformation or a scrolled 1-dimensional conformation upon a change to its ambient environment, where the change in the ambient environment is due to a change of one or more of the pH, ionic strength, temperature, pressure, sonication, and light in the ambient environment; and
the quantity of the plurality of functional groups is greater than that present in an unmodified form of the same two-dimensional nanomaterial.

8. The nanomaterial electrolyte according to claim 7, wherein the nanomaterial electrolyte is in an aqueous ambient environment.

9. The nanomaterial electrolyte according to claim 7, wherein the change in the ambient environment is due to a change of:
(a) one or more of the temperature, salt concentration, pH, ionic strength, and sonication in the ambient environment; or
(b) one or more of pH, ionic strength, and sonication in the ambient environment; or
(c) one or both of pH and sonication in the ambient environment.

10. The nanomaterial electrolyte according to claim 7, wherein the modified two-dimensional nanomaterial is selected from one or more of a graphene, a graphene oxide, a reduced graphene oxide, a hexagonal boron nitride, and a transition metal dichalcogenide.

11. The nanomaterial electrolyte according to claim 7, wherein the plurality of functional groups are selected from one or more of the group consisting of:
(a) amine, hydroxyl, carboxylic acid, thiol, and amide; or
(b) amino, hydroxyl, carboxylic acid, and thiol; or
(c) hydroxyl, carboxylic acid, and thiol; or
(d) carboxylic acid and thiol; or
(e) amine and imine;
(f) hydroxyl, carboxylic acid, and sulphonic acid; or
(g) thiol and sulphonamide; or
(h) amine and carboxylic acid.

12. The nanomaterial electrolyte according to claim 7, wherein one or both of the following apply:
(a) the nanomaterial electrolyte is further coated with a material selected from one or more of the group consisting of a polymer, a protein, a carbohydrate, and nanoparticles; and
(b) the nanomaterial electrolyte further comprises a fluorescent group covalently bonded to the surface.

13. A method of forming a nanomaterial electrolyte described in claim 7, the method comprising the steps of:
(i) providing an unmodified two-dimensional nanomaterial; and
(ii) reacting it with one or more functionalising reagents in the presence of a solvent to provide a nanomaterial electrolyte.

14. The method according to claim 13, wherein the unmodified two-dimensional nanomaterial is selected from one or more of a graphene, a graphene oxide, a reduced graphene oxide, a hexagonal boron nitride, and a transition metal dichalcogenide.

15. The method according to claim 13, wherein the one or more functionalising reagents are selected from compounds that provide the nanomaterial electrolyte with one or more functional groups selected from the group consisting of imine, sulfonic acid, sulfonamide or, more particularly, amine, hydroxyl, carboxylic acid, thiol, and amide.

16. The method according to claim 15 wherein the one or more functionalising reagents are selected from one or more of the group consisting of a thioamine, bifunctional sulphonic acid, an aminosilane, a carboxylicsilane, a thiolsilane, a bi-functional amine, a polyfunctional amine, an azido compound, a dienophile, a thioacid, and a haloacetamide.

17. The method according to claim 13, wherein one or more of the following apply:
(a) step (ii) in claim 13 is conducted using an activating molecule;
(b) the reaction product of step (ii) in claim 13 is subjected to reduction in a step (iii), which reduction step comprises reacting the reaction product of step (ii) with a reducing agent in the presence of a solvent; and
(c) the reaction product of step (ii) in claim 13 is subjected to reaction in a step (iv) with a fluorescent agent in the presence of a solvent.

18. A drug delivery device comprising:
a nanomaterial electrolyte as described in claim 7; and
a drug attached to a surface of the nanomaterial electrolyte, wherein
the nanomaterial electrolyte is provided in a scrolled 1-dimensional conformation, such that the drug is encapsulated within an interior of the scrolled 1-dimensional confirmation and is released when the nanomaterial electrolyte adopts a flat two-dimensional conformation upon exposure to an acidic or a basic environment.
